(19) United States
(12) Patent Application Publication
(10) Pub. No.: US 2007/0168587 A1
(43) Pub. Date: Jul. 19, 2007

(54) INPUT SWITCHING METHOD BY USING AN AUXILIARY KEYBOARD AND SUCH ARRANGEMENT

(75) Inventor: Tao-Cheng Yen, Chung Ho City, Taipei County (TW)

Correspondence Address: PAI PATENT & TRADEMARK LAW FIRM, 1001 FOURTH AVENUE, SUITE 3200, SEATTLE, WA, 98154, US

(73) Assignee: CHIC TECHNOLOGY CORP., Chung Ho City (TW)

(21) Appl. No.: 11/164,867

(22) Filed: Dec. 8, 2005

(51) Int. Cl. G06F 13/12

(52) U.S. Cl. 710/67

(57) ABSTRACT

An input switching arrangement by using an auxiliary keyboard is disclosed. Such arrangement comprises a main keyboard with a first set of keys and a first switching key, and at least an auxiliary keyboard each with a second set of keys and a second switching key. The main keyboard and the auxiliary keyboard are connected to a computer. The first switching key and the second switching key may send out a signal to the computer to switch the code mode. Because the code mode for each keyboard is determined by its corresponding status flag, the code mode for the main keyboard does not need to be tracked, and hence a user only has to adjust the status flag of the auxiliary keyboard so as to change the code mode for the auxiliary keyboard and to use the auxiliary keyboard along with the main keyboard.

### BACKGROUND OF THE INVENTION

1. Field of the Invention

The invention generally relates to an input switching arrangement by using an auxiliary keyboard. More particularly, the invention relates to an input switching arrangement that enables an auxiliary keyboard to send out codes in numeric mode or control mode without having to track the status of the status flag of the main keyboard.

2. Description of the Prior Art

Keyboard first appeared in the first mechanical typewriter invented by Mr. Christopher Latham Sholes in 1868. Keyboard has been widely used in computers, and numeric keys have been added to provide additional functionality. In the notebook computers, because of the limited space, numeric keys are incorporated into the typing keys, and a switching key, “num lock”, is used to switch between the numeric mode and the typing mode.

Such a switching key is quite inconvenient because a user has to press the switching key frequently and this hinders the continuity of the input operation and results in more typing errors.

An auxiliary keyboard has been used with a notebook computer. Such auxiliary keyboard is usually a small keyboard with numeric keys and control keys (such as direction keys) to make input operation easier. However, some keys of such auxiliary keyboard are already provided by the main keyboard; also, a user has to use the “num lock key” to switch between the main keyboard and the auxiliary keyboard. In addition, when a user wishes to input numbers, he has to switch to the numeric mode or decide whether the input mode should be altered by looking at the status flag. After he is done with the input of numbers, he has to switch back to the typing mode.

Such prior art arrangement causes a lot of inconvenience—especially when a user wishes to continuously input letters and numbers.

In Patent No. 220,492 (“input method by using a small keyboard”), a buffer memory is used to record the keypress data and the duration of a keypress is used to decide the correct output code so as to make the auxiliary keyboard compatible with the main keyboard and to minimize the problem that the auxiliary keyboard shares some keys with the main keyboard.

However, such prior art arrangement slows down the input operation and is time-consuming.

To eliminate the disadvantages of the prior art input switching methods, the inventor has put in a lot of effort in the subject and has successfully come up with the “input switching arrangement by using an auxiliary keyboard” of the present invention.

### SUMMARY OF THE INVENTION

The object of the present invention is to provide such input switching arrangement (by using an auxiliary keyboard): the code mode that the computer and the main keyboard are in does not need to be tracked, and an auxiliary keyboard is used to send out codes in numeric mode or control mode so that the main keyboard and the auxiliary keyboard may be used together more easily.

The input switching arrangement of the present invention comprises a main keyboard, at least an auxiliary keyboard, a first set of keys, a first switching key, a second set of keys and a second switching key. The main keyboard and the auxiliary keyboard are connected to a computer. The first set of keys is provided on the main keyboard and may send out a set of codes. The first switching key is provided on the main keyboard and may send out a signal to the computer so as to alter the status of a status flag of the first set of keys and to change the code mode of the first set of keys. The second set of keys is provided on the auxiliary keyboard and may send out a set of codes. The second switching key is provided on the auxiliary keyboard and may send out a signal to the computer so as to alter the status of a status flag of the second set of function keys and to change the code mode of the second set of keys.

The input switching arrangement of the present invention includes the following steps:

Either of the first set of keys of the main keyboard or the second set of keys of the auxiliary keyboard has its own set of codes, and the arrangement of the present invention is operable regardless of the status of the status flag of either keyboard.

If the main keyboard and the auxiliary keyboard are in the same mode, a user may use either switching key to alter the code mode so that the main keyboard and the auxiliary keyboard would be in different code modes. Similarly, if the keyboards are in different code modes, a user may use either switching key to make the main keyboard and the auxiliary keyboard operate in the same code mode.

### BRIEF DESCRIPTION OF THE DRAWINGS

The drawings disclose an illustrative embodiment of the present invention which serves to exemplify the various advantages and objects hereof, and are as follows:

FIG. 1 is a diagram schematically illustrating the input switching arrangement of the present invention.

FIG. 2 is a perspective view showing how the input switching arrangement of the present invention is used.

### DETAILED DESCRIPTION OF THE PREFERRED EMBODIMENTS

The present invention will be hereinafter described with reference to the drawings so that the present invention may be understood more easily.

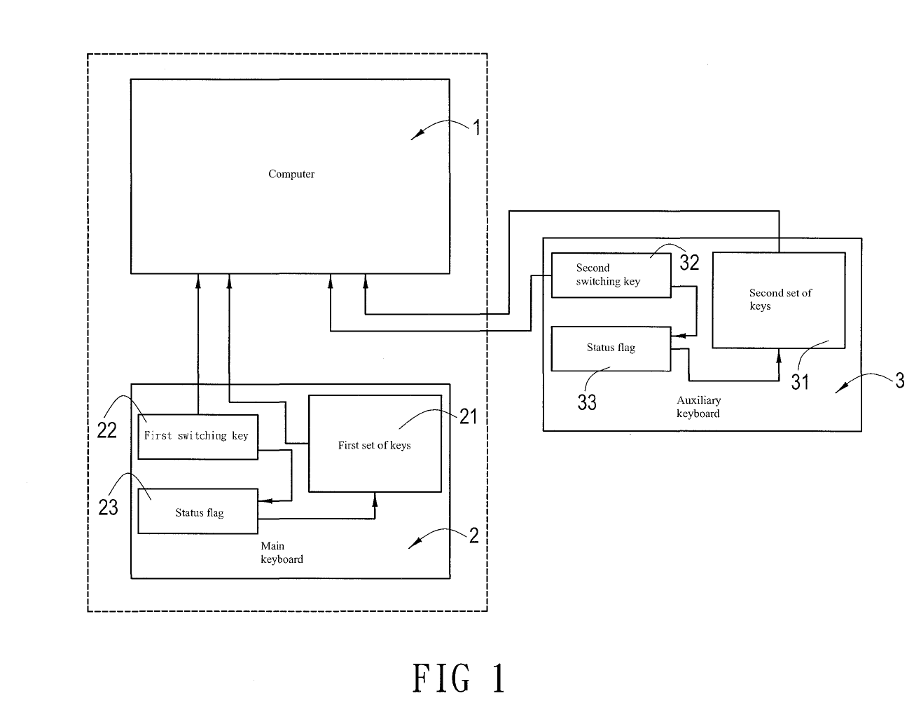

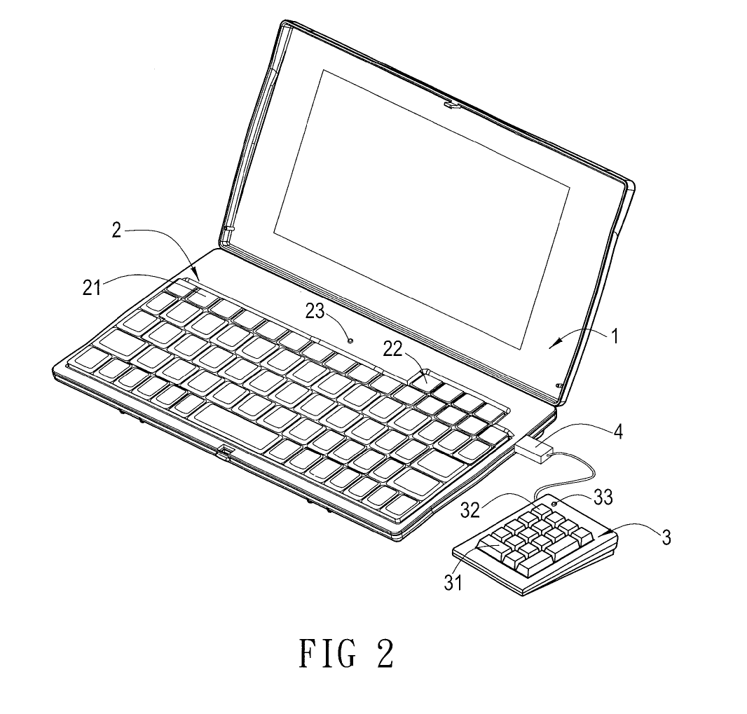

Please refer to FIGS. 1 and 2. The multiple keyboards input switching arrangement of the present invention comprises a main keyboard 2 and at least one auxiliary keyboard 3; the keyboards 2 and 3 are connected with a notebook computer 1.

A first set of keys 21 is provided on the main keyboard 2 and may send out codes in either of two code modes: numeric mode or control mode. A first switching key 22 is provided on the main keyboard 2 and may send out codes to the notebook computer 1; a user may use the first switching key 22 to alter the status of a status flag 23 so as to change the code mode that the first set of keys 21 is in.

A USB (universal serial bus) 4 is provided between the notebook computer 1 and the auxiliary keyboard 3. A second set of keys 31 is provided on the auxiliary keyboard 3 and may send out codes in numeric mode or control mode. A second switching key 32 is provided on the auxiliary keyboard 3; a user may use the second switching key 32 to alter the status of a status flag 33 so as to change the code mode that the second set of keys 31 is in.

As illustrated in FIGS. 1 and 2, the input switching arrangement of the present invention includes the following steps:

Either of the first set of keys 21 of the main keyboard 2 or the second set of keys 31 of the auxiliary keyboard 3 has its own set of codes. The arrangement of the present invention is operable regardless of the status of the status flag 23 and 33 of either keyboard.

If the first set of keys 21 of the main keyboard 2 and the second set of keys 31 of the auxiliary keyboard 3 are in the same code mode, a user may use the first switching key 22 to alter the code mode of the first set of keys 21 and the status of the status flag 23 of the main keyboard 2 or may also use the second switching key 32 to alter the code mode of the second set of keys 31 and the status of the status flag 33 so that the second set of keys 31 and the first set of keys 21 may be in different code modes.

The mode that either the main keyboard 2 or the auxiliary keyboard 3 is in is controlled by the status flag 23 (provided on the main keyboard 2) and the status flag 33 (provided on the auxiliary keyboard 3), respectively. If the auxiliary keyboard 3 is in the control mode and a user wishes to use the auxiliary keyboard 3 to input numbers (such as 1, 2, 3, 4, 5, 6, 7, 8, 9 and 0), he or she just has to press the second switching key (so as to switch to the numeric mode) and then input the numbers. Now, the status of the other status flag 23 remains unchanged and the user may use the main keyboard 2 along with the auxiliary keyboard. On the other hand, if the auxiliary keyboard 3 is in the numeric mode and a user wishes to use the auxiliary keyboard 3 to input controls (such as ↑, ↓, ←, →, home, page up, end, page down, ins and del), he or she simply has to press the second switching key (so as to switch to the control mode) and then input controls. Now, the status of the other status flag 23 remains unchanged and the user may use the main keyboard 2 along with the auxiliary keyboard.

From the above, we can see that: the independently-operated second switching key 32 provided on the auxiliary keyboard 3 may be used to alter the status of the status flag 33 of the second set of keys and hence may operate independently of the status flag 23 of the main keyboard 2. Whence, the present invention allows a user to easily switch between the numeric mode and the control mode so that he may input numbers and controls in a swift manner and may use the main keyboard 2 along with the auxiliary keyboard 3.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An input switching arrangement, comprising:
a main keyboard, connected to a computer;
at least an auxiliary keyboard, connected to the computer;
a first set of keys, provided on the main keyboard and able to send out a set of codes in any of a plurality of code modes;
a first switching key, provided on the main keyboard and able to send out a signal to the computer so as to alter the status of a status flag of the first set of keys and to change the code mode that the first set of keys is in;
a second set of keys, provided on the auxiliary keyboard and able to send out a set of codes in any of a plurality of code modes; and
a second switching key, provided on the auxiliary keyboard and able to send out a signal to the computer so as to alter the status of a status flag of the second set of keys and to change the code mode that the second set of keys is in.

2. The input switching arrangement as in claim 1, wherein a USB (universal serial bus) is used to facilitate the connection and transmission between the computer and the auxiliary keyboard.

3. The input switching arrangement as in claim 1, wherein the computer is a notebook computer.

4. The input switching arrangement as in claim 1, wherein the computer is a desktop computer.

5. The input switching arrangement as in claim 1, wherein the main keyboard may be the keyboard of a notebook computer.

6. The input switching arrangement as in claim 1, wherein the main keyboard is a conventional computer keyboard.

7. The input switching arrangement as in claim 1, wherein the first set of keys may send out codes in the numeric mode or control mode and the first switching key may be used to alter the status of the status flag of the first set of keys so as to switch between the numeric mode and control mode, and wherein the second set of keys may send out codes in the numeric mode or control mode and the second switching key may be used to alter the status of the status flag of the second set of keys so as to switch between the numeric mode and control mode.

8. An input switching method by using an auxiliary keyboard, which is used with the keyboard of a computer, comprising the following steps:
Either of the first set of keys of the main keyboard or the second set of keys of the auxiliary keyboard has its own set of codes, and the arrangement of the present invention is operable regardless of the status of the status flag of either keyboard;
If the main keyboard and the auxiliary keyboard are in different mode, a user may use either switching key to alter the code mode so that the main keyboard and the auxiliary keyboard would be in different code mode;
Because the code mode of either the main keyboard or the auxiliary keyboard is determined by its status flag, the mode that the main keyboard is in does not need to be tracked, and hence a user only has to adjust the status flag of the auxiliary keyboard so as to change the code mode that the auxiliary keyboard is in and so that the auxiliary keyboard may be used along with the main keyboard.
